(19) United States
(12) Patent Application Publication
(10) Pub. No.: US 2019/0087011 A1
(43) Pub. Date: Mar. 21, 2019

(54) METHOD AND SYSTEM FOR CONTROLLING VIRTUAL MODEL FORMED IN VIRTUAL SPACE

(71) Applicant: CENTER OF HUMAN-CETERED INTERACTION FOR COEXISTENCE, Seoul (KR)

(72) Inventors: Junsik KIM, Seoul (KR); Jung Min PARK, Seoul (KR); Bum-Jae YOU, Seoul (KR)

(73) Assignee: CENTER OF HUMAN-CENTERED INTERACTION FOR COEXISTENCE, Seoul (KR)

(21) Appl. No.: 16/129,652

(22) Filed: Sep. 12, 2018

(30) Foreign Application Priority Data
Sep. 18, 2017 (KR) 10-2017-0119703

(51) Int. Cl. G06F 3/01; G06T 19/20; G06T 19/00

(52) U.S. Cl. CPC G06F 3/017; G06T 19/006; G06T 19/20; G06F 3/011

(57) ABSTRACT

A virtual model control system and method for controlling a virtual model formed in virtual space are provided. The virtual model control system and method according to an embodiment of the present disclosure increases the accuracy of implementation by independently controlling two virtual objects combined with each other, and in the event of movement, performs location correction of the object so that their combination is maintained, thereby achieving more accurate control of the two virtual objects combined with each other.

### CROSS-REFERENCE TO RELATED APPLICATION

This application claims priority to Korean Patent Application No. 10-2017-0119703, filed on Sep. 18, 2017, and all the benefits accruing therefrom under 35 U.S.C. § 119, the contents of which in its entirety are herein incorporated by reference.

### BACKGROUND

### 1. Field

The present disclosure relates to a method and system for controlling a virtual model formed in virtual space, and more particularly, to a method and system for controlling two virtual objects constrained to each other by two hands in virtual space.

[Description about National Research and Development Support]

This study was supported by the Global Frontier Project of Ministry of Science, ICT, Republic of Korea (Development of Hand-based Seamless CoUI (Coexistence User Interface) for Collaboration between Remote Users, Project No. 1711052648, Sub-Project No. 2011-0031425) under the Korea Institute of Science and Technology.

### 2. Description of the Related Art

Recently, interfaces in virtual space are being actively studied. Among them, many techniques about natural user interfaces (NUI) using body motion as input means are being developed. Each part of a human body has a high degree of freedom. There is a need to implement free object manipulation using motions of human body parts in virtual space. In addition, there is a need for an approach to mapping an inputted hand shape to a virtual model and utilizing it to manipulate. However, in many cases, it is just recognizing and manipulating virtual objects of predefined gestures and predefined shapes. This is because it is difficult to achieve real-time fast and stable modeling due to complexity of the hand.

In this regard, more recently, interface techniques for detecting detailed motion of a human body and reflecting it as a virtual model in virtual space have been studied. These interfaces are generally implemented by detecting motion through a sensor device that is directly worn on a corresponding body part, or by detecting motion through an image sensor such as an RGBD sensor.

Meanwhile, technology that detects a user's hand motion, and changes the shape of a virtual object implemented in virtual space based on the detected motion is being developed together. However, when the shape of two virtual objects whose pose is limited through combination means, for example, a hinge and a slide, is deformed by manipulation using the user's hand in the same way as in reality, the degree of freedom between the two virtual objects is set higher than required and thus an unnecessary external force is generated between the two virtual objects, resulting in unstable position of the two virtual objects.

### SUMMARY

The present disclosure is designed to solve the above-described problem, and more particularly, the present disclosure provides a method and system for stably controlling two virtual objects constrained to each other by two hands in virtual space.

A virtual model control system according to an embodiment of the present disclosure is a virtual model control system for controlling a virtual model formed in virtual space, and includes an input device configured to provide input information for formation, movement or deformation of a virtual model, a control device configured to control a first virtual model and a second virtual model based on the input information, wherein the second virtual model is responsible for movement or deformation of the first virtual model in the virtual space, and an output device configured to output the first virtual model and the second virtual model, wherein the first virtual model has a structure in which at least two virtual objects are combined by combination means, and the control device configured to individually control the plurality of virtual objects, and when the first virtual model is moved or deformed by contact of the first virtual model and the second virtual model, the control device calculates corrected location for minimizing a degree of freedom of the plurality of virtual objects, and corrects a location of the first virtual model by adjusting a location of at least one of the plurality of virtual objects based on the optimization results.

In an embodiment, the corrected location may be a location at which the combination of the plurality of virtual objects is continuously maintained, and may be determined by optimizing parameter of the combination means.

In an embodiment, the first virtual model may have a structure in which two virtual objects are combined by a hinge, and the control device may optimize the parameter by approximating an angle θ formed by the two virtual objects.

In an embodiment, the second virtual model may be such that a plurality of physics particles is dispersively arranged on a boundary surface, and when the plurality of physics particles penetrates into the first virtual model by the contact, the control device may reposition the penetrating physics particles so that the penetrating physics particles are disposed outside of the first virtual model, and fix interactive deformation of the first virtual model and the second virtual model.

In an embodiment, the control device may calculate location of the repositioned physics particles and initial location of the plurality of virtual objects, and adjust the calculated initial location of the plurality of virtual objects to the corrected location.

In an embodiment, the control device may reset the fixed interactive deformation according to the corrected location of the first virtual model.

In an embodiment, the second virtual model may be a virtual hand model, and the input device may be a hand recognition device.

A virtual model control method according to an embodiment of the present disclosure is a method for controlling a virtual model including a first virtual model having a structure in which a plurality of virtual objects formed in virtual space is combined by combination means, and a second virtual model responsible for movement or deformation of the first virtual model, and includes forming and combining each of the plurality of virtual objects to form the first virtual model and forming the second virtual model, determining contact of the first virtual model and the second virtual model, calculating corrected location for minimizing a degree of freedom of the plurality of virtual objects, and correcting a location of the first virtual model by adjusting a location of at least one of the plurality of virtual objects based on the optimization results.

In an embodiment, the corrected location may be a location at which the combination of the plurality of virtual objects is continuously maintained, and may be determined by optimizing parameter of the combination means.

In an embodiment, the first virtual model may have a structure in which two virtual objects are combined by a hinge, and the parameter may be optimized by approximating an angle formed by the two virtual objects.

In an embodiment, the second virtual model may be such that a plurality of physics particles is dispersively arranged on a boundary surface, and the determining the contact of the first virtual model and the second virtual model may include, when the plurality of physics particles penetrates into the first virtual model by the contact of the first virtual model and the second virtual model, repositioning the penetrating physics particles so that the penetrating physics particles are disposed outside of the first virtual model, and fixing interactive deformation of the first virtual model and the second virtual model.

In an embodiment, the determining the contact of the first virtual model and the second virtual model may include calculating current location of the repositioned physics particles and initial location of the plurality of virtual objects, and the correcting the location of the first virtual model may include adjusting the calculated initial location of the plurality of virtual objects to the corrected location.

In an embodiment, the virtual model control method may further include, after the correcting the location of the first virtual model, resetting the fixed interactive deformation according to the corrected location of the first virtual model.

In an embodiment, the second virtual model may be a virtual hand model, and the second virtual model may be formed in response to skeletal motion information of a real hand recognized and transmitted by a hand recognition device.

The virtual model control system and method according to an embodiment of the present disclosure increases the accuracy of implementation by independently controlling two virtual objects combined with each other, and in the event of movement, performs location correction of each of the objects combined with each other, thereby achieving more accurate control of the two virtual objects combined with each other.

### BRIEF DESCRIPTION OF THE DRAWINGS

FIG. 1 is a schematic configuration diagram of a virtual model control system according to an embodiment of the present disclosure.

FIG. 2 shows a virtual hand implemented by the virtual model control system of FIG. 1.

FIG. 3 and FIGS. 4A-4D show a virtual space and a virtual model implemented in an output device of the virtual model control system of FIG. 1.

FIG. 5 schematically shows a location change of a first virtual model.

FIG. 6 is a flowchart of a virtual model control method according to an embodiment of the present disclosure.

### DETAILED DESCRIPTION

The following detailed description of the present disclosure is made with reference to the accompanying drawings, in which particular embodiments for practicing the present disclosure are shown for illustration purposes. These embodiments are described in sufficiently detail for those skilled in the art to practice the present disclosure. It should be understood that various embodiments of the present disclosure are different but do not need to be mutually exclusive. For example, particular shapes, structures and features described herein in connection with one embodiment can be embodied in other embodiment without departing from the spirit and scope of the present disclosure. It should be further understood that changes can be made to locations or arrangements of individual elements in each disclosed embodiment without departing from the spirit and scope of the present disclosure. Accordingly, the following detailed description is not intended to be taken in limiting senses, and the scope of the present disclosure is only defined by the appended claims along with the full scope of equivalents to which such claims are entitled. In the drawings, similar reference signs denote same or similar functions in many aspects.

The terms as used herein are general terms selected as those being now used as widely as possible in consideration of functions, but they may vary depending on the intention of those skilled in the art or the convention or the emergence of new technology. Additionally, in certain cases, there may be terms arbitrarily selected by the applicant, and in this case, the meaning will be described in the corresponding description part of the specification. Accordingly, the terms as used herein should be interpreted based on the substantial meaning of the terms and the content throughout the specification, rather than simply the name of the terms.

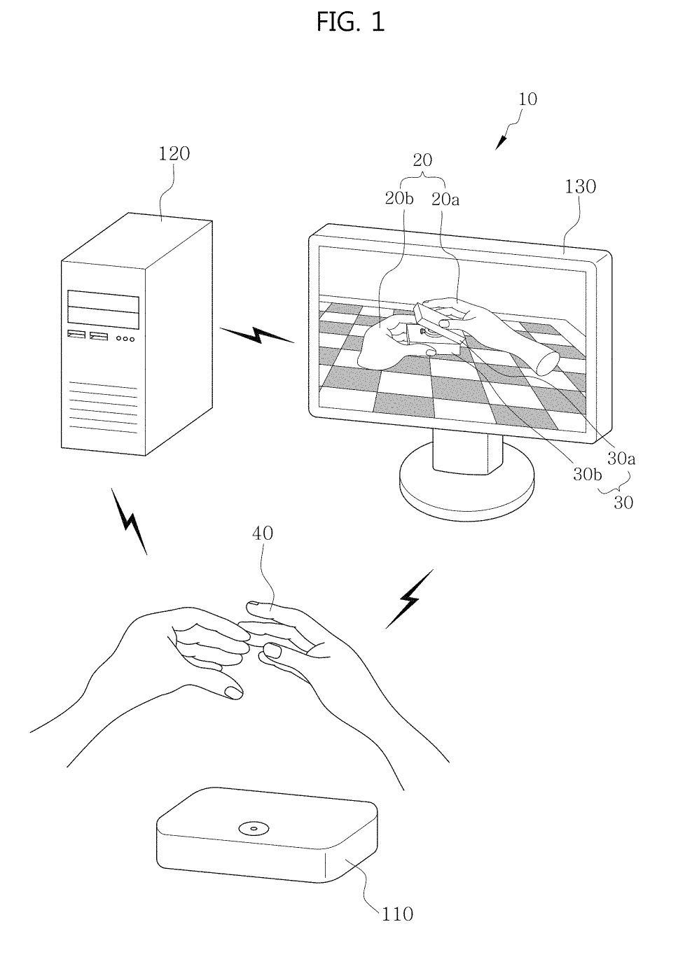

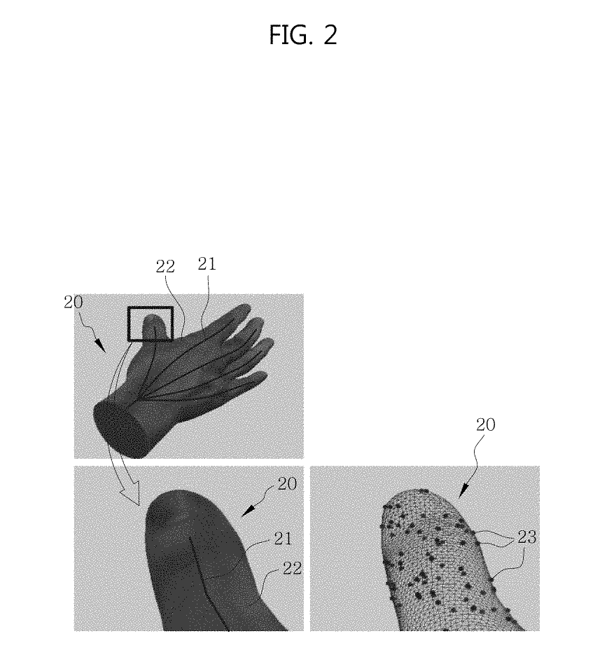

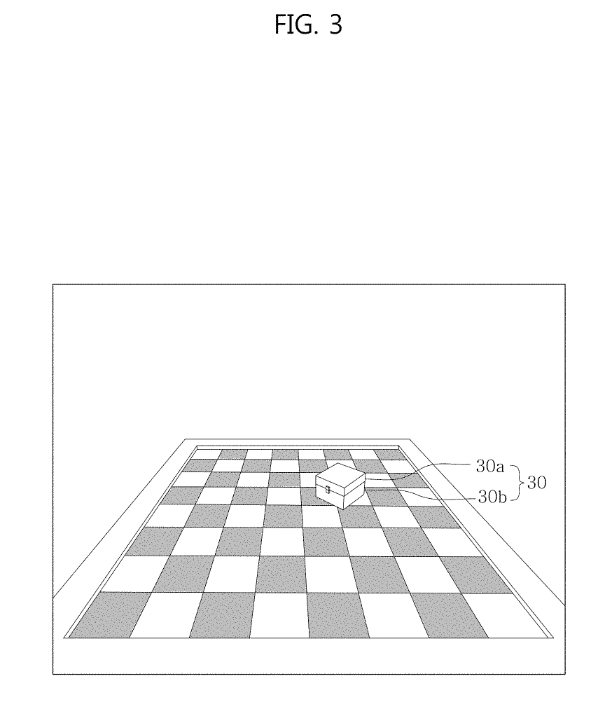

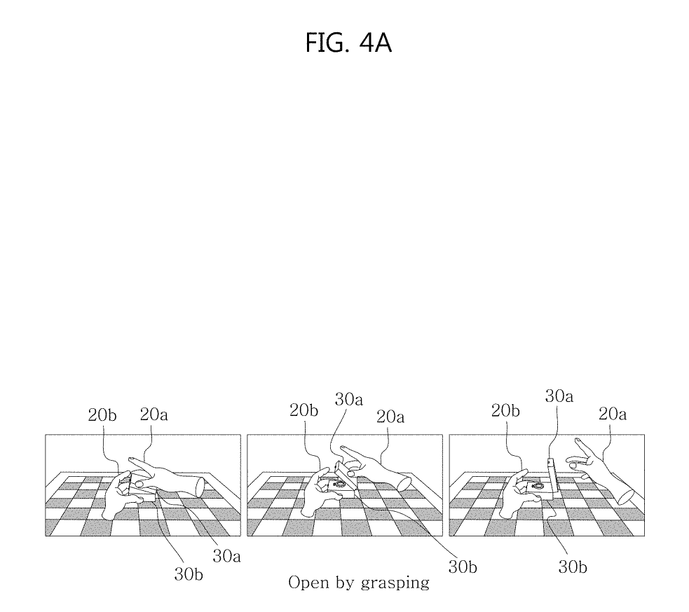

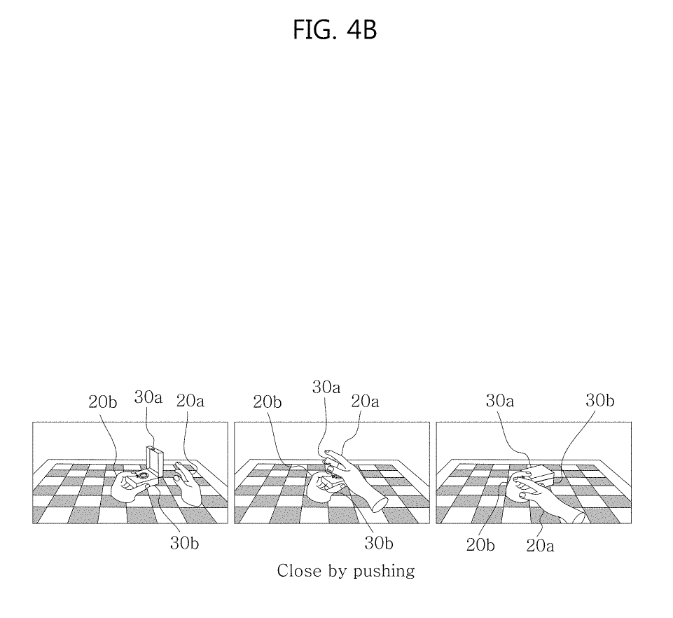

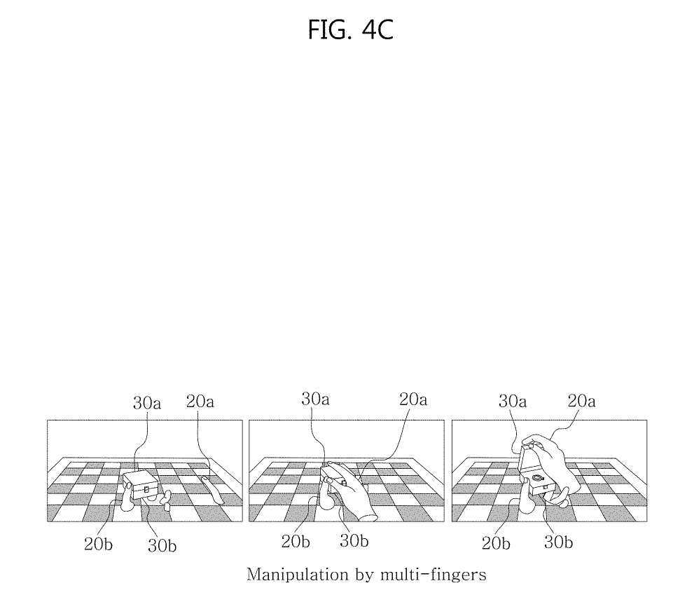

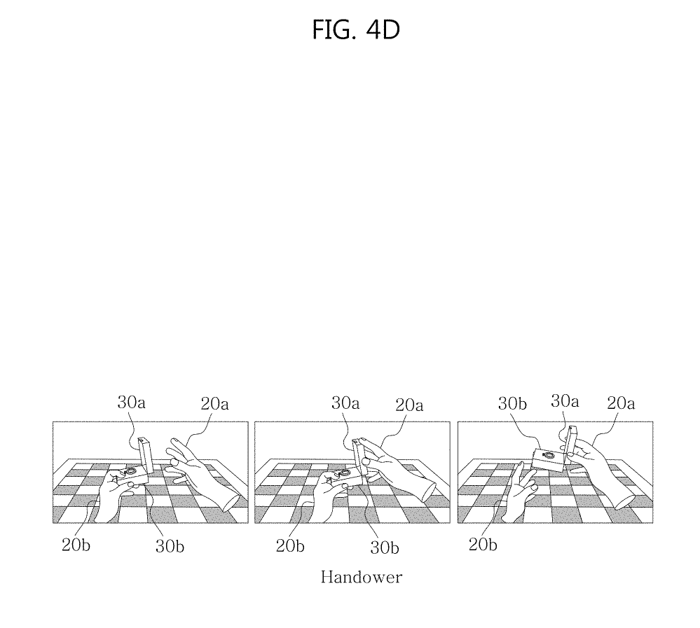

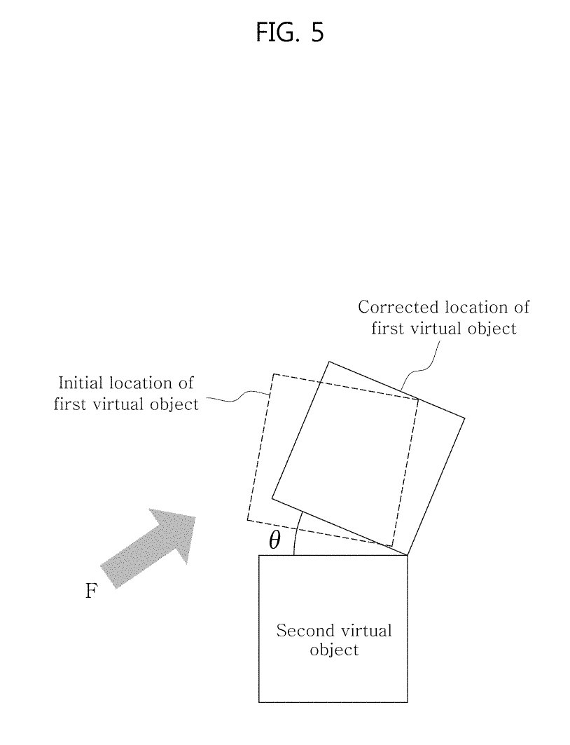

FIG. 1 is a schematic configuration diagram of a virtual model control system according to an embodiment of the present disclosure. FIG. 2 shows a virtual hand implemented by the virtual model control system of FIG. 1, FIG. 3 and FIGS. 4A-4D show a virtual space and a virtual model implemented in an output device of the virtual model control system of FIG. 1, and FIG. 5 schematically shows a location change of a first virtual model.

Referring to FIGS. 1 to 5, the virtual model control system 10 according to an embodiment of the present disclosure includes an input device 110, a control device 120 and an output device 130. The virtual model control system according to the embodiments and each device or unit that constitutes the system may have aspects of entirely hardware, or partly hardware and partly software. For example, each component of the virtual model control system is intended to refer to a combination of hardware and software that runs by the corresponding hardware. The hardware may be a data processing device including Central Processing Unit (CPU) or other processor. Additionally, the software that runs by the hardware may refer to a process in execution, an object, an executable, a thread of execution and a program. For example, the input device 110 may refer to a combination of hardware for recognizing an object and software that transforms to a format for producing input information by control of it.

The virtual model control system 10 according to an embodiment of the present disclosure implements physical interaction between virtual models that make physical motion and come into contact with each other in virtual space. The “virtual model” as used herein refers to any object or body having a predetermined physical quantity that exists in virtual space.

In this embodiment, a first virtual model 30 may be a specified object in virtual space, and a second virtual model 20 may be responsible for movement or deformation of the first virtual model 30 in virtual space. The second virtual model 20 may be a virtual hand 20 produced by recognition of the shape or location of a real hand 40, but is not limited thereto. Each virtual model 20, 30 may be inferred to perform physical motion in virtual space in the similar way to a real hand or a real object. However, the first and second virtual models 20, 30 are used for illustration purposes for convenience of understanding, and a variety of other objects or body parts may be implemented as virtual models.

The input device 110 may provide the control device 120 with input information for forming the first virtual model 30 and the second virtual model 20 in virtual space. The input device 110 may provide physical quantity, for example, a location, a shape, a size, a mass, a speed, a size and a direction of an applied force, friction coefficient and elastic modulus, as input information about the first and second virtual models 20, 30. Additionally, the input device 110 may provide a physical quantity variation such as a change in location, a change in shape and a change in speed to move or deform the first and second virtual models 20, 30.

The input device 110 may be a hand recognition device that can recognize the shape or location of the real hand 40. For example, the input device 110 may include a Leap Motion sensor. In addition, the input device 110 may include various types of known sensors including an image sensor such as a camera, and in particular, an RGBD sensor.

The input device 110 provides input information necessary to form the virtual hand 20. In this embodiment, the input device 110 may recognize the shape of the real hand 40, and based on this, infer the arrangement of skeleton 21 in the real hand 40. Accordingly, the input device 110 may provide input information for forming the skeleton 21 of the virtual hand 20. For example, when the real hand 40 is clenched, the input device 110 may infer the location of bones and joints that form each finger knuckle based on the detected shape, and thereby provide input information for forming the skeleton 21 of the virtual hand 20 so that the virtual hand 20 also has a clenched shape. Besides, the friction coefficient and mass necessary to implement the virtual hand 20 may be provided as a preset value.

Additionally, the input device 110 may detect a change in shape and location of the real hand 40, and based on this, provide input information necessary to move or deform the virtual hand 20. In this instance, when connection of bones and joints that form the virtual hand 20 and the degree of freedom at joints is preset, the input device 110 may provide input information in a simpler way by recognizing only the angle at which each bone is arranged in the real hand 40 and the location of joints. Although FIG. 2 shows only one virtual hand 20, the present disclosure is not limited thereto, and the user's two hands may be virtually implemented by receiving all information associated with the both hands.

Meanwhile, the input device 110 may provide input information by recognizing motion in real space through a separate sensor as described above, but may provide input information in a simple way by directly setting the physical quantity, for example, shape and location.

The control device 120 forms the first and second virtual models 20, 30 in virtual space based on the input information received from the input device 110. The virtual space has its own shape and size, and may be formed as a 3-dimensional space to which real-world physical laws are equally applied. The control device 120 forms the virtual model in this virtual space.

Here, as shown in FIG. 2, the virtual hand 20 may include boundary surface 22 that forms the shape and skeleton 21 disposed inside. The boundary surface 22 of the virtual hand 20 is spaced apart a predetermined distance from the skeleton 21 to form the shape of the virtual hand 20. The control device 120 may form the virtual hand 20 including the skeleton 21 made up of bones and joints, and the boundary surface 22 spaced apart a preset distance outward from the skeleton 21 to form the shape of the hand. However, the present disclosure is not limited thereto, and the virtual hand 20 may only include the boundary surface, not including the skeleton 21 therein, like the virtual object 30.

When input information about movement or deformation is received from the input device 110, the control device 120 moves or deforms the virtual hand 20 based on this. In this instance, the control device 120 may move or deform by individually controlling each part of the boundary surface 22 of the virtual hand 20, but in view of reducing an amount of computation for control, the control device 120 preferably moves or deforms the skeleton 21 of a relatively simple structure first, and moves the boundary surface 22 according to the movement of the skeleton 21.

The control device 120 forms a plurality of physics particles 23 on the virtual hand 20, and forms their contact point information. The plurality of physics particles 23 is particles of small size having any shape, and is dispersively arranged on the boundary surface 22 of the virtual hand 20. When directly moving or deforming all areas that form the boundary surface 22 of the virtual hand 20, an amount of computation for control is too much, and thus it is possible to indirectly control the virtual hand 20 with a simplified structure by forming the plurality of physics particles 23 at some areas on the boundary surface 22.

The plurality of physics particles 23 may have a variety of physical quantities. The plurality of physics particles 23 may have a location, a shape, a size, a mass, a speed, a size and a direction of an applied force, friction coefficient or elastic modulus. The plurality of physics particles 23 may be formed of spherical particles in unit size.

The control device 120 may change the location of the plurality of physics particles 23. As the virtual hand 20 is moved or deformed, the control device 120 may reposition the plurality of physics particles 23. That is, the control device 120 may track the changed location of the boundary surface 22 by movement or deformation of the virtual hand 20, and reposition the plurality of physics particles 23. However, the present disclosure is not limited thereto, and the control device 120 may deform the virtual hand 20 so that the boundary surface 22 is disposed at the location of the plurality of physics particles 23. That is, the control device 120 may implement the movement or deformation of the virtual hand 20 by moving the plurality of physics particles 23 first, and based on this, moving the part of the boundary surface 22 where the plurality of physics particles 23 is disposed.

The output device 130 outputs the virtual hand 20 and the virtual object 30 formed by the control device 120 to the outside. The output device 130 may be a 3-dimensional display device that allows the user to experience a spatial sensation, but is not limited thereto. The output device 130 may implement motion in real space more realistically in virtual space through matching with the input device 110. For example, the user's motion may be implemented in virtual space by mapping location information in real space recognized through the input device 110 to location information in virtual space outputted through the output device 130.

As shown in FIG. 3 and FIGS. 4A-4D, the output device 130 may output the implemented virtual space and the first and second virtual models 20, 30 implemented in the virtual space.

When the first virtual model 30 is produced, the physical quantity may be set. The virtual models have each shape and are disposed at each position. Additionally, the virtual models may be formed with deformable boundary surfaces like the virtual hand 20, or other necessary physical quantities may be directly set or may be set based on the input information received from the input device 110.

Here, the first virtual model 30 may be at least two virtual objects combined by combination means. In this embodiment, the first virtual model 30 may include two virtual objects, a first virtual object 30a and a second virtual object 30b, combined by combination means. The first virtual object 30a and the second virtual object 30b may have a hinge-combined structure, and may be in the shape of a box that is open and closed through a hinge. However, the present disclosure is not limited thereto, and two virtual objects may be constrained to each other to allow for sliding movement only, and may be applied to all cases where a plurality of virtual objects is combined by the medium of other constraint means.

Before the constraint, each of the first virtual object 30a and the second virtual object 30b may have six degrees of freedom (movement in the X-axis direction, movement in the Y-axis direction, movement in the Z-axis direction, rotation around the X-axis, rotation around the Y-axis, rotation around the Z-axis). However, because the first virtual object 30a and the second virtual object 30b are combined by the medium of combination means, the second virtual object 30b may be dependent on six degrees of freedom of the first virtual object 30a. Additionally, the positional relationship between the first virtual object 30a and the second virtual object 30b may be limited to an angle θ between the objects generated on the basis of the hinge. That is, the first virtual object 30a has six degrees of freedom, and the second virtual object 30b may have 1 degree of freedom (rotational movement by which the size of the angle θ changes) dependent on the first virtual object 30a.

The first virtual model 30 implemented in this embodiment has seven degrees of freedom dissimilar to a general virtual object having six degrees of freedom, so its shape may change more diversely. Thus, implementation of the first virtual model 30 as an object results in a very large amount of computation for control, so the application as a real-time interface may be difficult and the accuracy of implementation may reduce.

The control device 120 may individually form and control the plurality of virtual objects. The control device 120 may independently implement the first virtual object 30a and the second virtual object 30b, and then implement the entire first virtual model 30 by adjusting their positional relationship.

Movement of the first virtual object 30a and the second virtual object 30b in virtual space may be performed by the second virtual model 20. The second virtual model 20 may be a virtual hand 20 as described above, and a virtual right hand 20a and a virtual left hand 20b may be each implemented in virtual space.

As shown in FIGS. 4A-4D, the virtual left hand 20b may hold the second virtual object 30b, and the virtual right hand 20a may grasp the first virtual object 30a. In response to the motion of the virtual right hand 20a, the first virtual object 30a and the second virtual object 30b may have a motion by which the angle θ is changed on the basis of the hinge, and the box may be open and closed. Additionally, the location of the first virtual object 30a and the second virtual object 30b may be changed by finger manipulation. Additionally, a motion of transferring the virtual object 30 from the virtual left hand 20b to the virtual right hand 20a may be made.

However, because each of the first virtual object 30a and the second virtual object 30b is independently implemented as an object having physical quantity, when they are moved, additional location correction in response to the movement is necessary. Each of the first virtual object 30a and the second virtual object 30b corresponds to a single virtual object having its own degree of freedom but they are constrained to each other with combination means, and thus in order to move as a whole while maintaining the constrained state, optimization is necessary to reduce their degree of freedom. That is, optimization is necessary to minimize the degree of freedom so that the first virtual object 30a and the second virtual object 30b each having six degrees of freedom before combination by combination means have seven degrees of freedom as an object.

For example, when the first virtual object 30a and the virtual hand 20 are moved in contact, the force that will keep the first virtual object 30a and the second virtual object 30b in combined state acts in the opposite direction and the coordination position of the first virtual object 30a and the second virtual object 30b may be unstable. Additionally, in the case of rotational motion with the increasing or decreasing angle θ through the hinge, the first virtual object 30a and the second virtual object 30b should be able to continuously maintain the hinge-combined state. When the location of the first virtual object 30a and the second virtual object 30b is changed, the control device 120 according to this embodiment may perform nonlinear optimization to reduce the degree of freedom of the virtual objects, and the location of the first virtual object 30a and the second virtual object 30b may be adjusted by the optimization results. Additionally, the movement of the virtual object 30 is performed on the premise of contact with the virtual hand 20 as described above, and the above-described correction may be necessary from the time in point of contact with the virtual hand 20. Hereinafter, the correction process performed by the control device 120 will be described in more detail.

The control device 120 may detect a contact of the virtual object 30 and the virtual hand 20 in virtual space. When the contact of the virtual object 30 and the virtual hand 20 is detected, the control device 120 may collect their contact information. The contact may be such that the virtual left hand 20b holds the second virtual object 30b, and the virtual right hand 20a grasps the first virtual object 30a, but is not limited thereto.

The control device 120 may determine if part of the virtual hand 20 penetrates into the virtual object 30 by the movement or deformation of the virtual hand 20. By determining if some of the plurality of physics particles 23 are disposed in the virtual object 30, it can be determined if the boundary surface 22 where the penetrating physics particles 23 are disposed penetrates into the virtual object 30.

When part of the virtual hand 20 penetrates into the virtual object 30, the control device 120 may implement physical interaction between the virtual hand 20 and the virtual object 30. That is, the virtual hand 20 may be responsible of movement or deformation of the virtual object 30. To implement physical interaction, the penetrated part may be repositioned.

The control device 120 may reposition the penetrating physics particles 23 outside of the virtual object 30. Additionally, the control device 120 may move or deform the boundary surface 22 to conform to the repositioned physics particles 23. Meanwhile, when repositioning, the penetrating physics particles 23 may be positioned in contact with the surface of the penetrated virtual object 30. Additionally, the penetrating physics particles 23 may be moved in a direction perpendicular to the boundary surface of the virtual object 30.

The control device 120 may deform the boundary surface 22 of the virtual hand 20 so that the repositioned physics particles 23 and the boundary surface 22 of the virtual hand 20 match. In this instance, considering the distance between the physics particles 23 that will be narrower too much due to the repositioned physics particles 23, the boundary surface 22 and the physics particles 23 of the virtual hand 20 that have been already disposed outside of the virtual object 30 may be moved further outwards. Accordingly, it is possible to implement the shape of the hand that is deformed when grasping the object with the real hand. After the repositioning process, interactive deformation between the virtual hand 20 and the virtual object 30 in contact with each other may be fixed. When interactive deformation between the virtual hand 20 and the virtual object 30 is fixed, as the virtual hand 20 moves, the grasped virtual object 30 may move together.

Additionally, after the control device 120 repositions the penetrating physics particles 23, the other physics particles 23 may additionally penetrate into the virtual object 30 by continuous movement or deformation of the virtual hand 20. In this case, the control device 120 may reposition the additionally penetrating physics particles 23 again.

The control device 120 may collect contact information of each of the first virtual object 30a and the second virtual object 30b. The control device may collect contact information of each object based on the location of the repositioned physics particles 23, and using this, calculate the current location of the virtual object 30. The second virtual object 30b and the first virtual object 30a are a virtual object having physical quantity and may be spaced apart from each other, and the control device 120 may calculate the initial location of each of the second virtual object 30b and the first virtual object 30a.

The control device 120 may perform optimization to restrict the degree of freedom of the first virtual object 30a and the second virtual object 30b. The control device 120 may calculate corrected location at which the combined state of the first virtual object 30a and the second virtual object 30b is continuously maintained. Specifically, the control device 120 may calculate corrected location of the first virtual object 30a and the second virtual object 30b by optimizing parameters of the combination means.

When the first virtual object 30a and the second virtual object 30b are constrained to each other while being connected at a vertex, the relative position of the first virtual object 30a and the second virtual object 30b may be determined by the angle θ formed by the objects. Accordingly, the control device 120 may perform location correction of the first virtual object 30a and the second virtual object 30b through an algorithm for approximation of the angle θ. As shown in FIG. 5, the control device 120 may correct at least one of the second virtual object 30b and the first virtual object 30a from the initial location to the corrected location. The approximation of the angle θ formed by the first virtual object 30a and the second virtual object 30b may be defined as the following Equation 1.

$$arg {min}_{θ} {\sum }_{i} \vert {p}_{i} - {p}_{i}^{′} ( R ( θ ) , t ( θ ) ) \vert \qquad [ Equation 1 ]$$

Here, Pi denotes the vertex at initial location, i denotes the location (index) of Pi, P′i denotes the vertex at the corrected location determined by R(θ) and t(θ), and R(θ) and t(θ) are calculated by the given constraint relationship.

For example, when the hinge axis corresponds to the x-axis in the coordinate of the first virtual object, and the pivot point is p₂ in the coordinate of the second virtual object and corresponds to p_{g} in the coordinate of the first virtual object, R(θ) and t(θ) may be defined as the following Equation 2.

$$R ( θ ) = [ \begin{matrix}1 & 0 & 0 \\ 0 & cos θ & - sin θ \\ 0 & sin θ & cos θ\end{matrix} ] , t ( θ ) = {p}_{g} - R ( θ ) {p}_{2} \qquad [ Equation 2 ]$$

The control device 120 may calculate the corrected location by finding a solution of the above [Equation 1]. The above [Equation 1] may derive a result value using a nonlinear equation by a function optimization method such as Levenberg-Marquardt method. The control device 120 may perform location correction of at least one of the second virtual object 30b and the first virtual object 30a according to the calculated corrected location. For example, location correction of only the first virtual object 30a from the initial location to the corrected location may be performed, but the present disclosure is not limited thereto, and in some embodiments, location correction of both the first virtual object 30a and the second virtual object 30b from the initial location to the corrected location may be performed.

Additionally, a change in the contact location of the virtual hand 20 and the virtual object 30 may occur by the location correction of the first virtual object 30a or the second virtual object 30b. Accordingly, the control device 120 may reset the fixed interactive deformation between the virtual hand 20 and the virtual object 30 in response to the location correction of the virtual object 30. The control device 120 may fix the interactive deformation to match to the current location of the virtual object 30 and the location of the virtual hand 20.

The output device 130 may output the corrected virtual object 30 and the virtual hand 20, and the above-described correction process may be continuously performed while movement of the virtual object 30 occurs by the virtual hand 20, and in particular, position movement occurs by constraint means.

The virtual model control system according to an embodiment of the present disclosure increases the accuracy of implementation by independently controlling two virtual objects combined with each other, and in the event of movement, performs location correction of the object so that their combination is maintained, thereby achieving more accurate control of the two virtual objects combined with each other.

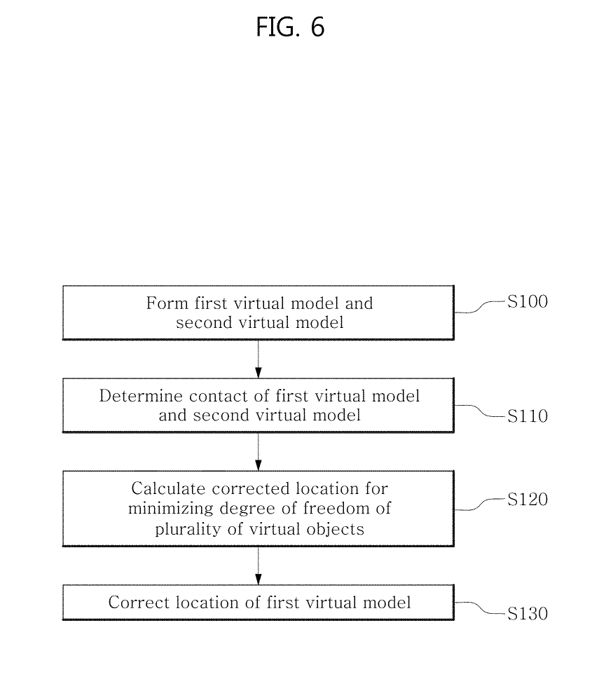

Hereinafter, a virtual model control method according to an embodiment of the present disclosure will be described. FIG. 6 is a flowchart of the virtual model control method according to an embodiment of the present disclosure.

Referring to FIG. 6, the virtual model control method according to an embodiment of the present disclosure is a method for controlling a virtual model formed in virtual space, and includes forming a first virtual model and a second virtual model (S100), determining a contact of the first virtual model and the second virtual model (S110), calculating corrected location for minimization of the degree of freedom of a plurality of virtual objects (S120), and correcting the location of the first virtual model (S130).

Here, a virtual model control system that performs each of the above-described steps may be the virtual model control system 10 of FIG. 1 described above, and its detailed description is omitted herein. Additionally, for description of this embodiment, a reference may be made to FIGS. 1 to 5.

First, a first virtual model and a second virtual model are formed (S100).

The virtual model control system 10 includes the input device 110, the control device 120 and the output device 130.

The first virtual model 30 may be a specified object in virtual space, and the second virtual model 20 may be responsible for movement or deformation of the first virtual model 30 in virtual space. The second virtual model 20 may be a virtual hand 20 produced by recognition of the shape or location of a real hand 40, but is not limited thereto. Each virtual model 20, 30 may be inferred to perform physical motion in virtual space in the similar way to a real hand or a real object.

Input information for forming the first and second virtual models 20, 30 may be produced by the input device 110, and the input information may be provided to the control device 120. The input device 110 provides input information necessary to form the virtual hand 20. In this embodiment, the input device 110 may recognize the shape of the real hand 40, and based on this, infer the arrangement of skeleton 21 in the real hand 40. Accordingly, the input device 110 may provide input information for forming the skeleton 21 of the virtual hand 20. The input device 110 may be a hand recognition device that can recognize the shape or location of the real hand 40. For example, the input device 110 may include a Leap Motion sensor. In addition, the input device 110 may include various types of known sensors including an image sensor such as a camera, and in particular, an RGBD sensor.

The control device 120 forms the first and second virtual models 20, 30 in virtual space based on the input information received from the input device 110. The virtual space has its own shape and size, and may be formed as a 3-dimensional space to which real-world physical laws are equally applied. The control device 120 forms the virtual model in this virtual space.

Here, the first virtual model 30 may be at least two virtual objects combined by combination means. In this embodiment, the first virtual model 30 may include two virtual objects, a first virtual object 30a and a second virtual object 30b, combined by combination means. The first virtual object 30a and the second virtual object 30b may have a hinge-combined structure, and may be in the shape of a box that is open and closed through a hinge. However, the present disclosure is not limited thereto, and two virtual objects may be constrained to each other to allow for sliding movement only, and may be applied to all cases where a plurality of virtual objects is combined by the medium of other constraint means.

Dissimilar to conventional general virtual objects, the first virtual model 30 implemented in this embodiment can move with seven degrees of freedom, not six degrees of freedom, so its shape may change more diversely. Thus, implementation of the first virtual model 30 as an object results in a very large amount of computation for control, so the application as a real-time interface may be difficult and the accuracy of implementation may reduce. Accordingly, the control device 120 may individually form and control the plurality of virtual objects. That is, the control device 120 may independently implement the first virtual object 30a and the second virtual object 30b, and then implement the entire first virtual model 30 by adjusting their positional relationship.

Subsequently, a contact of the first virtual model and the second virtual model is determined (S110).

Because each of the first virtual object 30a and the second virtual object 30b is independently implemented as an object having physical quantity, when they are moved, additional location correction in response to the movement is necessary. Substantially, each of the first virtual object 30a and the second virtual object 30b corresponds to a single virtual object having its own degree of freedom, but they are constrained to each other by combination means, and thus in order to move as a whole while maintaining the constrained state, correction is necessary to reduce their degree of freedom.

Additionally, the movement of the virtual object 30 is performed on the premise of contact with the virtual hand 20 as described above, and the above-described correction may be necessary from the point in time of contact with the virtual hand 20.

The contact of the virtual object 30 and the virtual hand 20 may be detected through the control device 120. When the contact of the virtual object 30 and the virtual hand 20 is detected, the control device 120 may collect their contact information. The contact may be such that the virtual left hand 20b holds the second virtual object 30b, and the virtual right hand 20a grasps the first virtual object 30a, but is not limited thereto.

The control device 120 forms a plurality of physics particles 23 on the virtual hand 20, and forms their contact point information. The plurality of physics particles 23 is particles of small size having any shape, and is dispersively arranged on the boundary surface 22 of the virtual hand 20. When directly moving or deforming all areas that form the boundary surface 22 of the virtual hand 20, an amount of computation for control is too much, and thus it is possible to indirectly control the virtual hand 20 with a simplified structure by forming the plurality of physics particles 23 at some areas on the boundary surface 22.

The plurality of physics particles 23 may have a variety of physical quantities. The plurality of physics particles 23 may have a location, a shape, a size, a mass, a speed, a size and a direction of an applied force, friction coefficient or elastic modulus. The plurality of physics particles 23 may be formed of spherical particles in unit size.

The control device 120 may determine if part of the virtual hand 20 penetrates into the virtual object 30 by the movement or deformation of the virtual hand 20. By determining if some of the plurality of physics particles 23 are disposed in the virtual object 30, it can be determined if the boundary surface 22 where the penetrating physics particles 23 are disposed penetrates into the virtual object 30.

When the plurality of physics particles 23 penetrates into the first virtual model 30 by the contact of the first virtual model 30 and the second virtual model 20, the step (S110) of determining the contact of the first virtual model 30 and the second virtual model 20 may include repositioning the penetrating physics particles 23 so that the penetrating physics particles are disposed outside of the first virtual model 30, and fixing interactive deformation of the first virtual model and the second virtual model.

When part of the virtual hand 20 penetrates into the virtual object 30, the control device 120 may implement physical interaction between the virtual hand 20 and the virtual object 30. That is, the virtual hand 20 may be responsible of movement or deformation of the virtual object 30. To implement physical interaction, the penetrated part may be repositioned. The control device 120 may reposition the penetrating physics particles 23 outside of the virtual object 30. After the repositioning process, interactive deformation between the virtual hand 20 and the virtual object 30 in contact with each other may be fixed. When interactive deformation between the virtual hand 20 and the virtual object 30 is fixed, as the virtual hand 20 moves, the grasped virtual object 30 may move together.

The step (S110) of determining the contact of the first virtual model 30 and the second virtual model 20 may include collecting, by the control device 120, contact information of each of the first virtual object 30a and the second virtual object 30b. The step (S110) of determining the contact of the first virtual model 30 and the second virtual model 20 includes calculating the location of the repositioned physics particles and the initial location of the plurality of virtual objects. The control device 120 may collect each contact information based on the location of the repositioned physics particles 23, and by making use of this, may calculate the current location of the virtual object 30. The second virtual object 30b and the first virtual object 30a each is a virtual object having physical quantity and may be spaced apart from each other, and the control device 120 may calculate the current location of each of the second virtual object 30b and the first virtual object 30a.

Corrected location for minimization of the degree of freedom of the plurality of virtual objects is calculated (S120).

The control device 120 may perform optimization to restrict the degree of freedom of the first virtual object 30a and the second virtual object 30b. The control device 120 may calculate corrected location at which the combined state of the first virtual object 30a and the second virtual object 30b is continuously maintained. Specifically, the control device 120 may calculate corrected location of the first virtual object 30a and the second virtual object 30b by optimizing the parameters of combination means.

When the first virtual object 30a and the second virtual object 30b are constrained to each other while being connected at a vertex, the relative position of the first virtual object 30a and the second virtual object 30b may be determined by an angle θ formed by the objects. In the case of rotational motion with the increasing or decreasing the angle θ through the hinge, the first virtual object 30a and the second virtual object 30b should be able to continuously maintain the hinge-combined state. When the location of the first virtual object 30a and the second virtual object 30b is changed, the control device 120 according to this embodiment may perform nonlinear optimization to reduce the degree of freedom of the virtual objects. Accordingly, the control device 120 may calculate corrected location of the first virtual object 30a and the second virtual object 30b through an algorithm for approximation of the angle θ. The algorithm for approximation of the angle θ may be derived according to the above-described Equation 1, but is not limited thereto.

Subsequently, the location of the first virtual model is corrected (S130).

The location of at least one of the first virtual object 30a and the second virtual object 30b may be corrected according to the optimization results. As shown in FIG. 5, the control device 120 may correct the location of the first virtual model by correcting the location of at least one of the second virtual object 30b and the first virtual object 30a from the initial location to the corrected location.

A change in the contact location of the virtual hand 20 and the virtual object 30 may occur by the location correction of the first virtual object 30a or the second virtual object 30b. Accordingly, the virtual model control method according to an embodiment of the present disclosure may further include, after the step (S130) of correcting the location of the first virtual model 30, resetting the interactive deformation of the first virtual model 30 and the second virtual model 20.

The fixed interactive deformation of the virtual hand 20 and the virtual object 30 may be reset in response to the location correction of the virtual object 30. The control device 120 may fix the interactive deformation to match to the current location of the virtual object 30 and the location of the virtual hand 20.

The virtual model control method according to an embodiment of the present disclosure increases the accuracy of implementation by independently controlling two virtual objects combined with each other, and in the event of movement, performs location correction of the object so that their combination is maintained, thereby achieving more accurate control of the two virtual objects combined with each other.

The operation by the virtual model control method according to the embodiments as described above may be implemented as a computer program at least in part and recorded on a computer-readable recording media. The computer-readable recording medium having recorded thereon the program for implementing the operation by the virtual model control method according to the embodiments includes any type of recording device in which computer-readable data is stored. Examples of the computer-readable recording media include ROM, RAM, CD-ROM, magnetic tape, floppy disk, and optical data storing devices. Additionally, the computer-readable recording media is distributed over computer systems connected via a network so that computer-readable codes may be stored and executed in distributed manner. Additionally, functional programs, codes and code segments for realizing this embodiment will be easily understood by those having ordinary skill in the technical field to which this embodiment belongs.

The present disclosure has been hereinabove described with reference to the embodiments, but the present disclosure should not be interpreted as being limited to these embodiments or drawings, and it will be apparent to those skilled in the corresponding technical field that modifications and changes may be made thereto without departing from the spirit and scope of the present disclosure set forth in the appended claims.

What is claimed is:

1. A virtual model control system for controlling a virtual model formed in virtual space, comprising:
an input device configured to provide input information for formation, movement or deformation of a virtual model;
a control device configured to control a first virtual model and a second virtual model based on the input information, wherein the second virtual model is responsible for movement or deformation of the first virtual model in the virtual space; and
an output device configured to output the first virtual model and the second virtual model,
wherein the first virtual model has a structure in which at least two virtual objects are combined by combination means, and
the control device configured to individually control the plurality of virtual objects and when the first virtual model is moved or deformed by contact of the first virtual model and the second virtual model, the control device calculates corrected location for minimizing a degree of freedom of the plurality of virtual objects, and corrects a location of the first virtual model by adjusting a location of at least one of the plurality of virtual objects.

2. The virtual model control system according to claim 1, wherein the corrected location is a location at which the combination of the plurality of virtual objects is continuously maintained, and is determined by optimizing parameter of the combination means.

3. The virtual model control system according to claim 2, wherein the first virtual model has a structure in which two virtual objects are combined by a hinge, and
the control device configured to optimize the parameter by approximating an angle formed by the two virtual objects.

4. The virtual model control system according to claim 1, wherein the second virtual model is such that a plurality of physics particles is dispersively arranged on a boundary surface, and
when the plurality of physics particles penetrates into the first virtual model by the contact, the control device repositions the penetrating physics particles so that the penetrating physics particles are disposed outside of the first virtual model, and fixes interactive deformation of the first virtual model and the second virtual model.

5. The virtual model control system according to claim 4, wherein the control device calculates location of the repositioned physics particles and initial location of the plurality of virtual objects, and adjusts the calculated initial location of the plurality of virtual objects to the corrected location.

6. The virtual model control system according to claim 4, wherein the control device resets the fixed interactive deformation according to the corrected location of the first virtual model.

7. The virtual model control system according to claim 1, wherein the second virtual model is a virtual hand model, and the input device is a hand recognition device.

8. A virtual model control method for controlling a virtual model including a first virtual model having a structure in which a plurality of virtual objects formed in virtual space is combined by combination means, and a second virtual model responsible for movement or deformation of the first virtual model, the virtual model control method comprising:
combining each of the plurality of virtual objects to form the first virtual model, and forming the second virtual model;
determining contact of the first virtual model and the second virtual model;
calculating corrected location for minimizing a degree of freedom of the plurality of virtual objects; and
correcting a location of the first virtual model by adjusting a location of at least one of the plurality of virtual objects.

9. The virtual model control method according to claim 8, wherein the corrected location is a location at which the combination of the plurality of virtual objects is continuously maintained, and is determined by optimizing parameter of the combination means.

10. The virtual model control method according to claim 9, wherein the first virtual model has a structure in which two virtual objects are combined by a hinge, and
the parameter is optimized by approximating an angle formed by the two virtual objects.

11. The virtual model control method according to claim 8, wherein the second virtual model is such that a plurality of physics particles is dispersively arranged on a boundary surface, and
the determining the contact of the first virtual model and the second virtual model comprises, when the plurality of physics particles penetrates into the first virtual model by the contact of the first virtual model and the second virtual model, repositioning the penetrating physics particles so that the penetrating physics particles are disposed outside of the first virtual model, and fixing interactive deformation of the first virtual model and the second virtual model.

12. The virtual model control method according to claim 11, wherein the determining the contact of the first virtual model and the second virtual model comprises calculating current location of the repositioned physics particles and initial location of the plurality of virtual objects, and
the correcting the location of the first virtual model comprises adjusting the calculated initial location of the plurality of virtual objects to the corrected location.

13. The virtual model control method according to claim 11, further comprising:
after the correcting the location of the first virtual model,
resetting the fixed interactive deformation according to the corrected location of the first virtual model.

14. The virtual model control method according to claim 8, wherein the second virtual model is a virtual hand model, and
the second virtual model is formed in response to skeletal motion information of a real hand recognized and transmitted by a hand recognition device.
